(19) United States
(12) Patent Application Publication
(10) Pub. No.: US 2006/0219850 A1
(43) Pub. Date: Oct. 5, 2006

(54) Structure of a supporting rack of a candle stand

(76) Inventor: Chuan-Chuan Chang, Siansi Township (TW)

Correspondence Address: TROXELL LAW OFFICE PLLC, SUITE 1404, 5205 LEESBURG PIKE, FALLS CHURCH, VA, 22041, US

(21) Appl. No.: 11/072,442

(22) Filed: Mar. 7, 2005

(51) Int. Cl. F16M 11/00

(52) U.S. Cl. 248/175

(57) ABSTRACT

A candle stand includes several supporting racks, and cup-shaped seats; the supporting racks are spaced apart; the candle stand is secured on a wall or positioned on a table; each supporting rack has an U-shaped supporting portion, which faces upwards at the opening thereof; the cup-shaped seats are used for holding a candle; each cup-shaped seat has an U-shaped groove on a middle of an outer side thereof; the U-shaped supporting portions of the supporting racks are tightly fitted in the U-shaped grooves of the cup-shaped seats respectively such that the cup-shaped seats are securely held in position, and they can't be changed in the orientation in relation to the U-shaped supporting portions.

Referring to FIG. 1, a conventional candle stand 2 is available, which can be secured to a wall or positioned on a table. The candle stand 2 includes several loop-shaped supporting racks 21, which are usually circular. Cup-shaped seats 3 are passed into the spaces encompassed by the loop-shaped supporting racks 21, and secured in position while candles P are held on respective ones of the cup-shaped seats 3. Thus, the candles P are arranged in a particular way, and will look more attractive together when burning.

The cup-shaped seats 3 are likely to be changed in the orientation in relation to the respective loop-shaped supporting racks 21 if the supporting racks 21 are circular. Consequently, the drawings on the cup-shaped seats 3 won't face forwards, and in turn the look of the whole candle stand is spoiled. To avoid the above problem, the cup-shaped seats 3 can only be printed with non-directional patterns thereon. Furthermore, the candles P are prone to fall down to cause danger if the cup-shaped seats 3 are accidentally hit at the bottoms.

It is a main object of the present invention to provide a candle stand whose cup-shaped seats for candles have U-shaped grooves, and are tightly fitted on U-shaped supporting portions of the candle stand at the U-shaped grooves.

It is another object of the present invention to provide a candle stand whose cup-shaped seats for candles have U-shaped grooves, and are secured in position by U-shaped supporting portions of the candle stand. The U-shaped supporting portions are tightly fitted in the U-shaped grooves. Therefore, the cup-shaped seats can't possibly be hit at the bottoms, and fall off the U-shaped supporting portions.

It is yet another object of the present invention to provide a candle stand whose cup-shaped seats for candles have U-shaped grooves, and are secured in position by U-shaped supporting portions of the candle stand. The U-shaped supporting portions are fitted in the U-shaped groove. Therefore, the cup-shaped seats can't possibly be changed in the orientation in relation to the U-shaped supporting portions, and the drawings and patterns on the cup-shaped seats, which drawings and patterns can be symmetric or non-symmetric, will always face forwards.

Referring to FIGS. 2 and 4, a first preferred embodiment 4A of a candle stand of the invention is secured on a wall for use, and includes several supporting racks 4, and cup-shaped seats 5. And, FIG. 3 shows a second preferred embodiment 4B of a candle stand of the invention, which is positioned on a table for use.

Each supporting rack 4 has an U-shaped supporting portion 41, which faces upwards at the opening. Each cup-shaped seat 5 has an U-shaped groove 51 on a middle of an outer side thereof. The U-shaped supporting portions 41 of the supporting racks 4 are respectively tightly fitted in the U-shaped grooves 51 of the cup-shaped seats 5 such that the cup-shaped seats 5 are secured in position. And, candles P are held in the cup-shaped seats 5 respectively. Therefore, it is impossible for the cup-shaped seats 5 to be hit at the bottoms and fall off the supporting racks 4.

Furthermore, it is impossible for the cup-shaped seats 5 to be changed in the orientation in relation to the supporting racks 4. In other words, the drawings on the cup-shaped seats 5 will always face forwards.

In addition, the internal width 41R of the top of each U-shaped supporting portion 41 is preferably slightly smaller than the internal width 51R of the top of each U-shaped groove 51; thus, the U-shaped supporting portions 41 will grip the cup-shaped seats 5.

### BRIEF DESCRIPTION OF THE DRAWINGS

FIG. 1 is an exploded perspective view of the conventional candle stand,

FIG. 2 is a fragmentary exploded perspective view of the present invention,

FIG. 3 is an exploded perspective view of the second embodiment, and

FIG. 4 is a partial vertical section of the present invention.

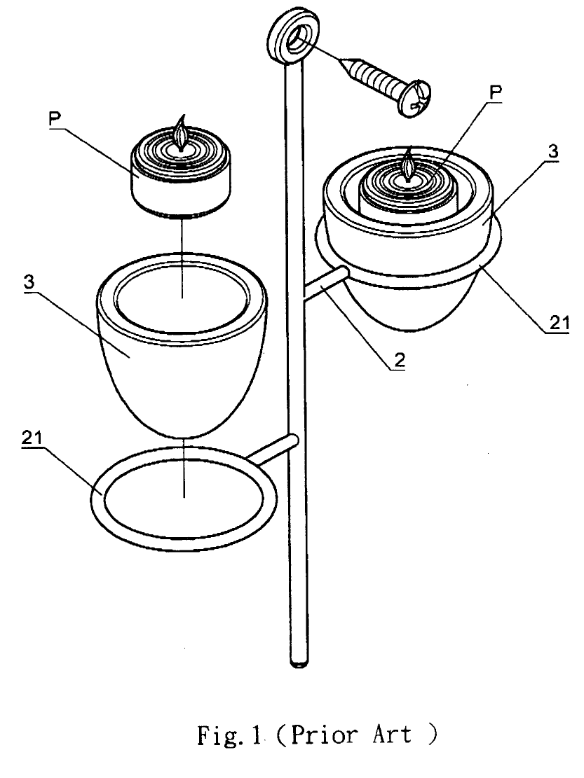

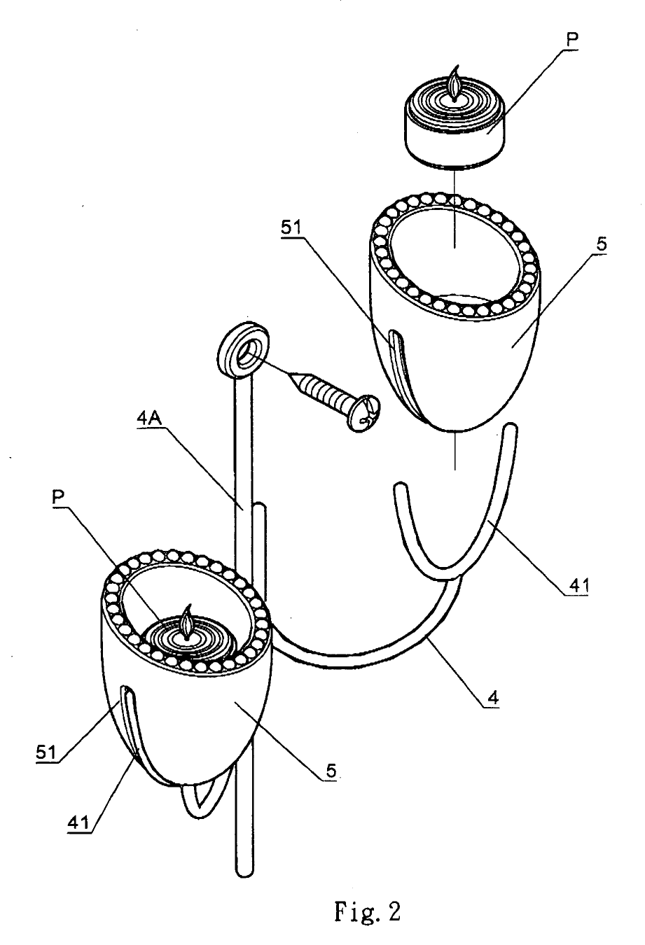

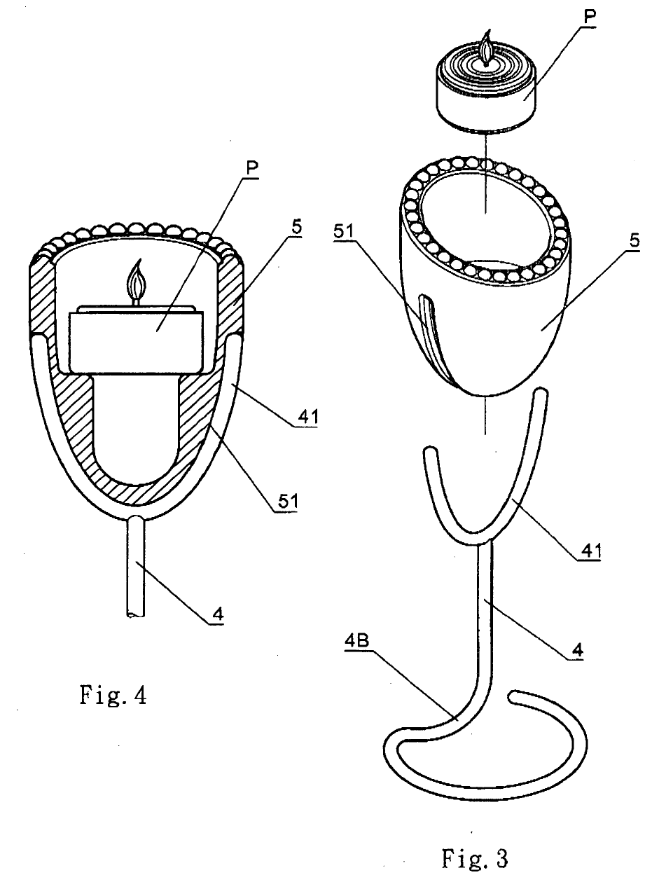

1-2. (canceled)

3. A candle stand structure comprising:
a) a candle stand having at least one supporting portion having a U-shape having two arms extending upwardly; and
b) at least one seat having a hollow cup shape and a U-shaped groove located on an exterior thereof, the U-shaped groove extending upwardly from a bottom of the at least one seat along each of two opposing sides thereof, one supporting portion is selectively inserted into each U-shaped groove connecting each of the at least one seat to the candle stand.

4. The candle stand structure according to claim 3, wherein the candle stand includes a base.

5. The candle stand structure according to claim 3, wherein the candle stand includes a connector ring.

6. The candle stand structure according to claim 3, wherein an internal width at a top of the at least one supporting portion is less than an internal width at a top of the U-shaped groove.
